(19) United States
(12) Patent Application Publication
(10) Pub. No.: US 2016/0327249 A1
(43) Pub. Date: Nov. 10, 2016

(54) Adjustable Length Articulated LED Light Fixtures

(71) Applicant: Tempo Industries, LLC, Irvine, CA (US)

(72) Inventors: Dennis Pearson, Foothill Ranch, CA (US); Wesley Scott Dochnahl, Upland, CA (US); Guang Jin, Santa Monica, CA (US)

(73) Assignee: Tempo Industries, LLC, Irvine, CA (US)

(21) Appl. No.: 15/215,566

(22) Filed: Jul. 20, 2016

Related U.S. Application Data
(62) Division of application No. 13/974,393, filed on Aug. 23, 2013, now Pat. No. 9,429,283.
(60) Provisional application No. 61/812,059, filed on Apr. 15, 2013.

(51) Int. Cl. F21V 19/00; F21V 29/70; F21V 29/89; F21V 21/26

(52) U.S. Cl. CPC F21V 19/0055; F21V 21/26; F21V 29/70; F21V 29/89; F21Y 2115/10

(57) ABSTRACT

An LED light fixture comprising a housing and a cover component, the cover component being shaped to inter-fit with the housing component and carrying one or more LED's. Self-threading screws are inserted into respective angled screw insertion holes in the cover component so as to bite into a surface of the housing component to thereby attach the cover component to the housing component and enhance heat transfer between the housing and cover components.

### CROSS REFERENCE TO RELATED APPLICATIONS

This application is a divisional of and claims the benefit of and priority to U.S. patent aplication Ser. No, 13/974,393, filed Aug. 23, 2013, and to U.S. Provisional Patent Application Ser. No. 61/812,059, filed Apr. 15, 2013, both entitled, “Adjustable Length Articulated Led Light Fixtures,” the contents of each of which is hereby incorporated by reference herein in its entirety.

### FIELD OF THE DISCLOSURE

The subject disclosure relates to lighting fixtures and more particularly to smaller scale articulated LED light fixtures installable as a series of interconnected articulated lighting units or modules and having a length adjustment feature.

### RELATED ART

Various decorative and/or accent linear lighting apparatus such as rope light, incandescent lighting, and festoon lighting have been in use for some time.

### SUMMARY

The following is a summary description of an illustrative LED lighting fixture embodiment. It is provided as a preface to assist those skilled in the art to more rapidly assimilate the detailed design discussion which ensues and is not intended in any way to limit the scope of the claims which are appended hereto in order to particularly point out the invention. According to one embodiment, an LED light fixture is provided comprising a housing and a cover component shaped to inter-fit with the housing and carrying one or more LED's. Self-threading screws are inserted into respective angled screw insertion holes in the cover component so as to bite into a surface of the housing component to thereby attach the cover component to the housing component and to pull the components together in order to enhance heat transfer between them.

### BRIEF DESCRIPTION OF THE DRAWINGS

FIG. 1 is an exploded perspective view illustrating the components of first and second adjacent interconnected LED light modules according to an illustrative embodiment;

FIG. 2 is a side sectional view of first and second interconnected LED light modules;

FIG. 3 is a fragmentary perspective view illustrating a module interconnection mechanism according to an illustrative embodiment;

FIG. 4. is a fragmentary perspective view further illustrating the interconnection mechanism of FIG. 3;

FIG. 5 is a top view of two interconnected modules according to an illustrative embodiment;

FIG. 6 is a perspective view of the underside of a cover component according to an illustrative embodiment;

FIG. 7 is an end sectional view of an illustrative embodiment;

FIG. 8 is an end perspective view further illustrating a portion of the interconnection mechanism of the illustrative embodiment;

FIG. 9 is an end perspective view of a base component of a module according to an illustrative embodiment; and

FIG. 10 is a fragmentary perspective view illustrating an end closure component according to an illustrative embodiment.

### DETAILED DESCRIPTION

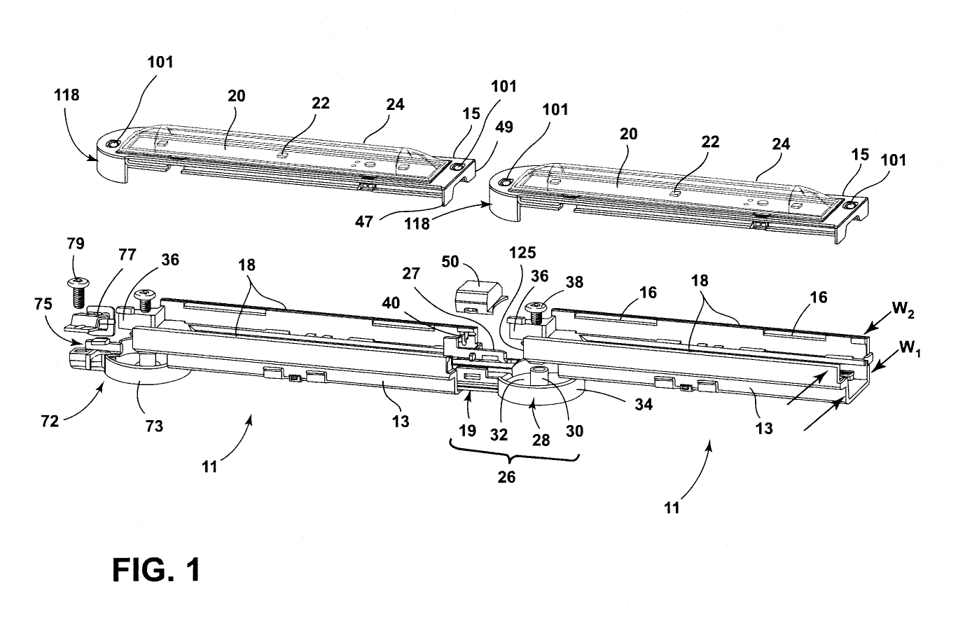

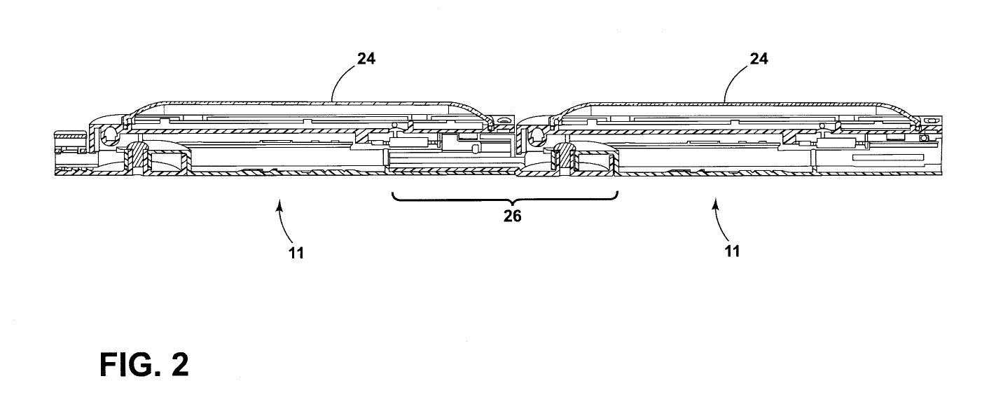

As shown in FIGS. 1 and 2, an illustrative modular light fixture apparatus may comprise a plurality of modules 11, each module having a base component 13 and a cover component 15. In one embodiment, each base 13 and each cover 15 of each module 11 may be identically shaped and fabricated of the same material. The base 13 may be constructed, for example of a zinc alloy such as ZAMAK 3 or other suitable materials.

In an illustrative embodiment, the base 13 has a lower channel of U-shaped cross-section of a first width W₁, which supports an upper channel of rectangular cross-section and of a width W₂ greater than the first width W₁. The cover 15 is generally rectangular, and in one embodiment, may be dimensioned to rest on horizontal ledges, e.g. 16, formed just below the upper horizontal edges 18 of the base 13. The cover 13 further has a semi-cylindrical cap 118 of a first radius R₁ formed at a nose or front end thereof. The cover 13 receives and mounts a generally rectangular circuit board 20 carrying one or more LED's 22 and positioned within a lens or cover 24.

An interconnection mechanism or component 26 is positioned beneath an inner end 125 of the right-most base component 13 of FIG. 1. The interconnection component 26 includes a generally cylindrical pivoting interconnection portion or component 28 and an interconnecting tongue portion or component 19. In one illustrative embodiment, the tongue 19 and cylindrical portion 28 are formed as single unitary component, for example, formed of die-cast aluminum, a zinc alloy such as ZAMAK 3, plastic, or other material. The cylindrical portion 28 has a cylindrical male projection or boss 30 formed on its floor 32. In the illustrative embodiment, the boss 30 is concentrically positioned with respect to the outer cylindrical wall 34.

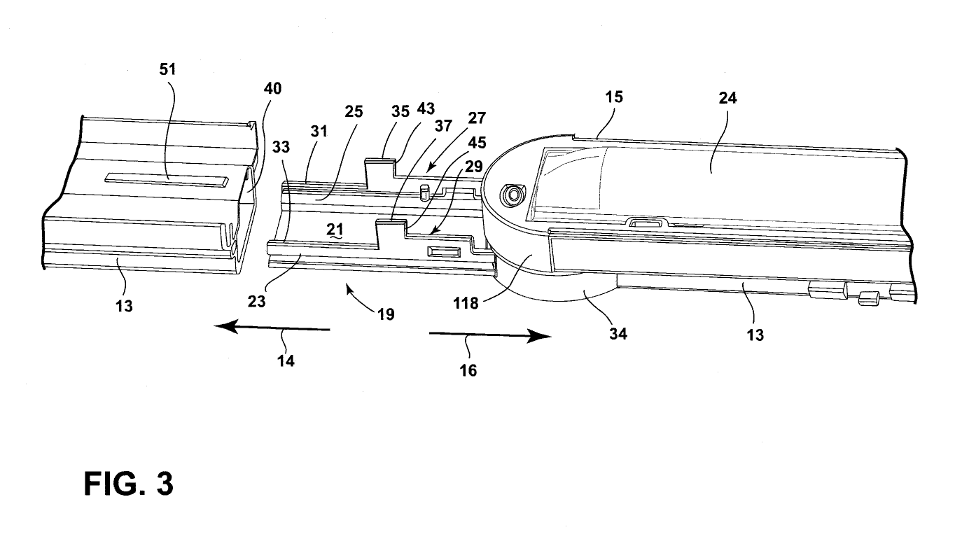

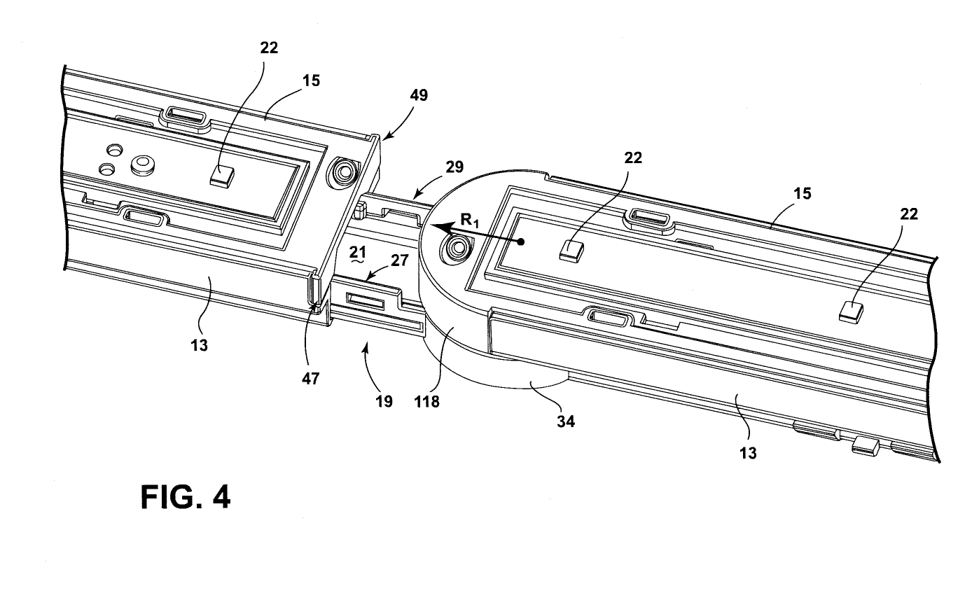

Each base 13 has an extended plug 36 formed at its inner end 125, which includes a through hole therein for receiving a screw 38. The screw 38 threads into the boss 30 of the cylindrical portion 28 of the interconnection mechanism 28 so as to pivotally mount the base 13 with respect to the interconnection component or mechanism 26. In one embodiment, the depth of insertion of the screw 38 is controlled to enable such pivotal movement. The semi-cylindrical cap 118 of the cover 15 may have the same radius R₁ (FIG. 4) as the outer wall 34 of the cylindrical portion 28 and may be positioned such that its contoured vertical outer surface mates flush with the vertical outer wall 34 and at the same time covers the extended plug 36, as shown, for example, in FIGS. 3 and 4, to give a clean appearance to the assembled unit or module 11.

As may be further seen in FIGS. 3 and 4, the tongue 19 has a rectangular floor 21 and respective vertical sides 23, 25. First and second vertical side rails 27, 29, are formed at an upper edge 31, 33 of each of the side rails 23, 25, and respective upwardly projecting rectangular tabs 35, 37 are formed at an end of each of the side rails 27, 29, as shown in FIG. 3.

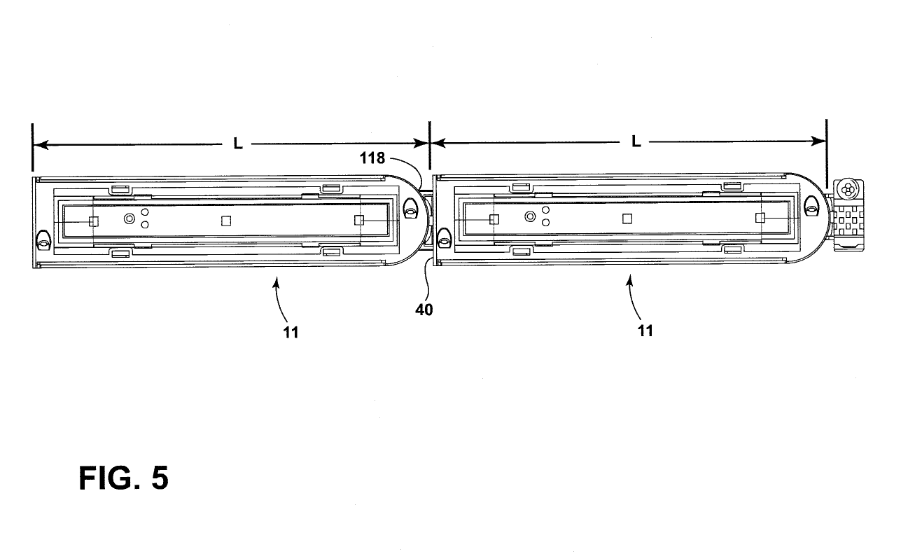

In one embodiment, as shown in FIG. 3, the inner end 40 of the adjacent left-most base component 13 and the tongue 19 are designed such that the tongue 19 slidingly mates with the end 40 of the left-most base component 13, such that the tongue 19 may move or slide horizontally into the left-most base 13 in the direction of the arrow 14 to a point where the tongue 19 is largely concealed and such that the semi-circular cap end 118 of the cover 15 lies adjacent the end 40 of the adjacent base 13, for example, as shown in FIG. 5. Similarly, the tongue 19 may slide horizontally out of the left-most base 13 in the direction of the arrow 16 of FIG. 3 to separate the units or modules 11 and extend their overall length.

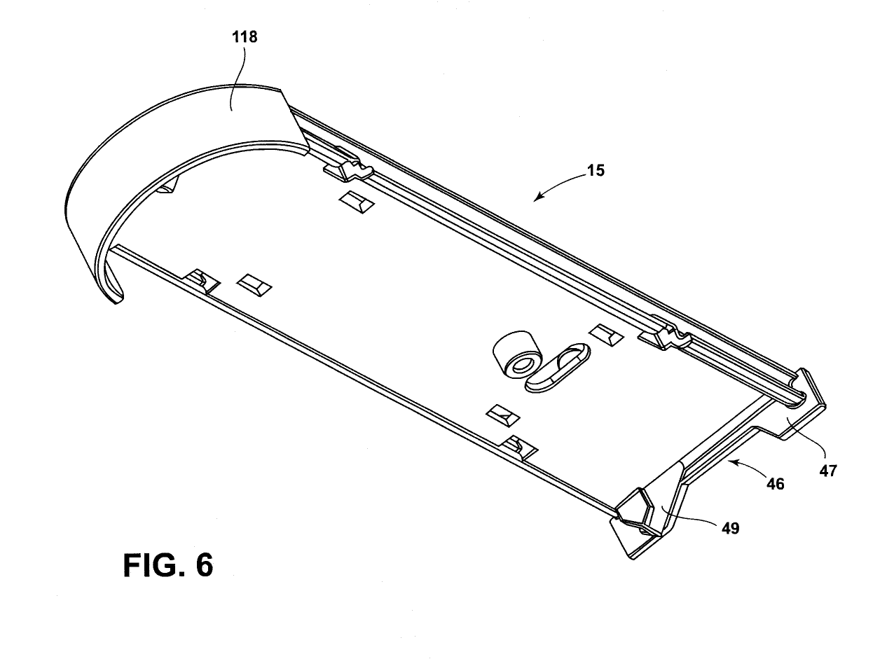

The extent to which the tongue 19 can slide or move out of the base 13 in the direction of the arrow 16 is limited by the vertically extending tabs 35, 37, whose vertical front edges 43, 45 are positioned to abut respective vertical depending surfaces 47, 49 (FIG. 4, FIG. 6) formed at an inner end 46 of the cover 15. In one embodiment, the tabs 35, 37 are positioned and dimensioned such that the tongue 19 may be extended to an extent providing an additional ½ inch of overall length to that of the two modules 11. In that position, in one illustrative embodiment, a cover cap 50 (FIG. 1) may be mounted over the rails 27, 29 to conceal them, thereby providing a more aesthetically pleasing appearance. In one embodiment, when the tongue 19 slides into the adjacent base component 13, the cover cap 50 slides into the base component 13 with it, as further illustrated in FIG. 5.

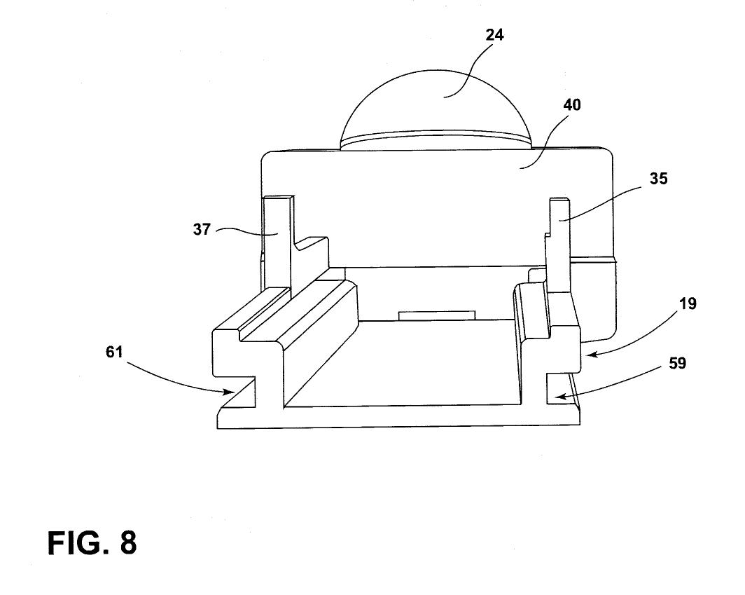

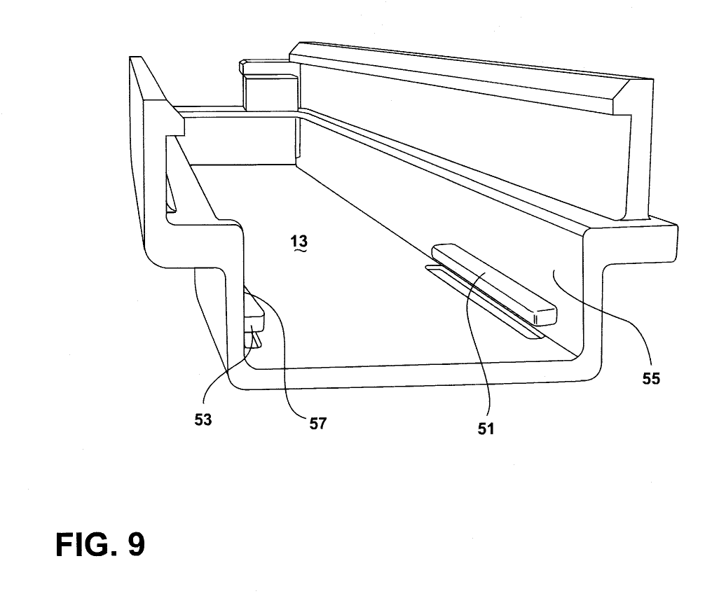

In an illustrative embodiment, as shown in FIGS. 8 and 9, to facilitate the in and out sliding movement of the tongue 19, respective rails 51, 53 are formed on the respective interior surfaces of the lower vertical walls 55, 57 of the base 13. Respective grooves 59, 61 are formed on opposite sides of the tongue 19 and are shaped and dimensioned to slidingly mate with or slidingly engage the rails 51, 53 such that the tongue 19 may slide into and out of the base 13. In another embodiment, grooves could be formed in the base sidewalls and rails on the tongue sidewalls to enable sliding movement. Various other constructions could be used to achieve the desired sliding extension and retraction of the tongue in various embodiments. Once extended to the desired amount, the modules 11 or mounting brackets attached to the modules 11 may be screwed or otherwise fastened into place to maintain the desired spacing.

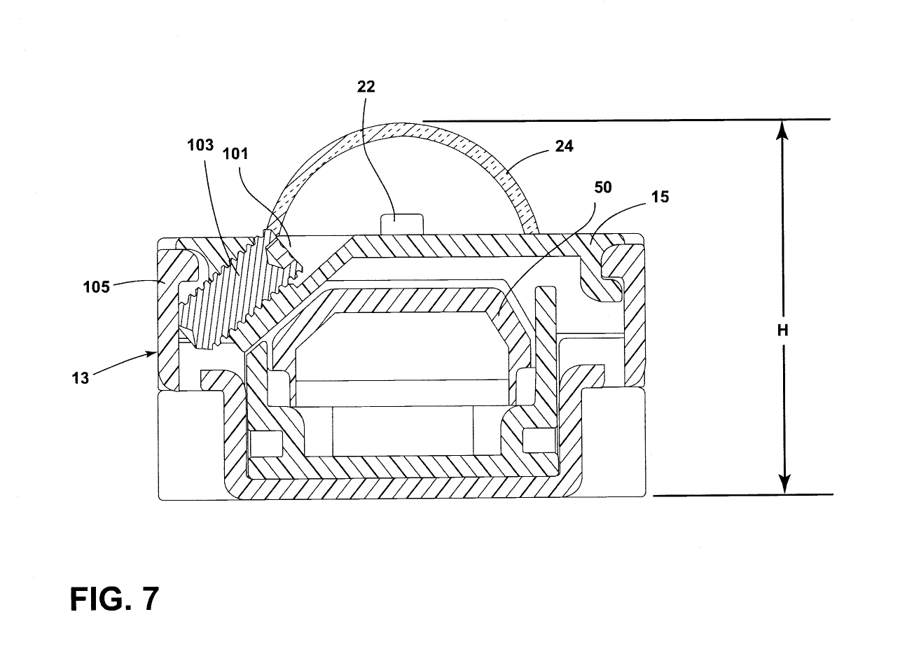

As shown in FIG. 1, in one embodiment each cover 15 may be provided with angled screw insertion holes 101 at opposite ends thereof. These holes 101 are positioned such that screws 103 may be inserted therein and then screwed in so as to bite into surfaces 105 of the housing or base component 13 as shown in FIG. 7 to pull the base 13 and cover 15 components tightly together so as to facilitate heat transfer and thermal management. In one embodiment, this screw insertion technique also insures proper alignment of the base 13 with respect to the cover 15 since the cover 15 will “pop out” if the screws 103 are not properly angled during insertion.

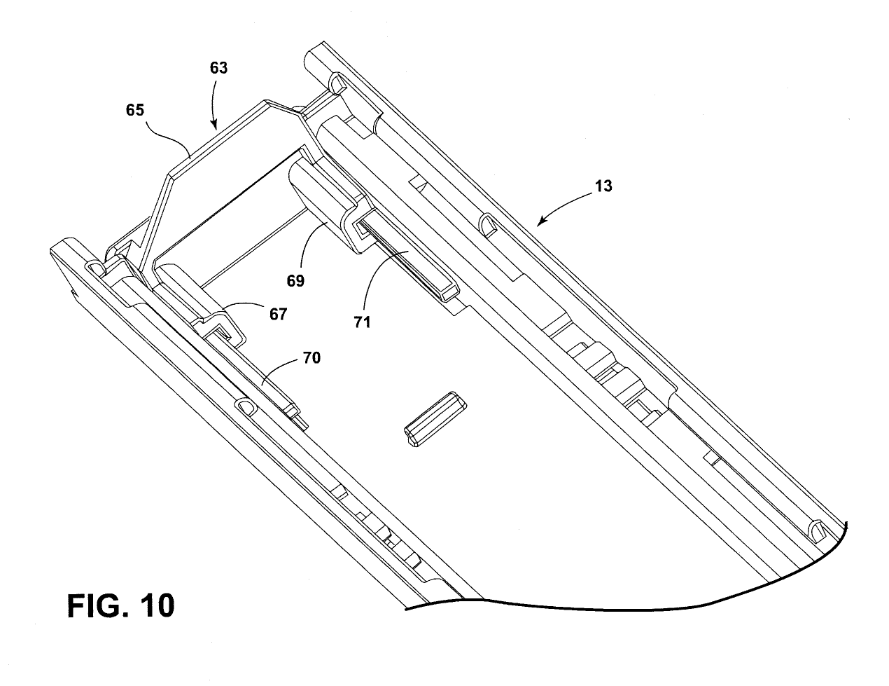

As shown in FIG. 10, an end plug 63 having a generally flat rectangular back surface 65 may be provided with side flanges 67, 69 suitably grooved to mate with respective side rails 70, 71 on the base 13, such that the plug 63 may slide in to close an open end of a base component 13 which constitutes the base component 13 of the last module 11 in an interconnected string of articulated modules 11.

At an opposite end of an interconnected string of modules 11, an end component 72 (FIG. 1) may be provided. This component 72 has a cylindrically shaped portion 73 constructed like portion 28 of the interconnection member 26, so as to flushly and conformably mate with the end cap 118 of the last or end cover component 15. In one embodiment, the end component 72 also has an extension portion, or channel 75 of u-shaped cross-section which may receive an electrical power cable held in place by an end cap 77 and screw 79. While FIG. 1 illustrates two modules 11 pivotally interconnected together, it will be appreciated that three or more modules 11 may be interconnected or strung together in the manner disclosed herein above.

In one embodiment, each module 11 may have a length (FIG. 5) of 5.98 inches, or roughly 6 inches, and a height (FIG. 7) of 1.04 inches, or roughly one inch. Such dimensions may of course be different in different embodiments.

Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. The LED light fixture apparatus comprising:
a housing;
a cover component shaped to inter-fit with the housing component, the cover component having a plurality of screw insertion holes therein, each of said screw insertion holes being disposed at an angle to the horizontal;
a circuit board mounted to the cover component and carrying one or more LED's;
a plurality of screws, each screw being inserted into a respective screw insertion hole and screwed into a surface of said housing component so as to bite into said surface to thereby attach said cover component to the housing component.

2. The LED light fixture apparatus of claim 1 wherein the housing and cover component are each constructed of heat conductive material and are further configured such that screwing said plurality of screws into the surface of said housing component pulls the housing and cover components together so as to facilitate heat transfer between them for thermal management purposes.

3. The LED light fixture apparatus of claim 2 wherein said heat conductive material comprises a zinc alloy.

4. The LED light fixture apparatus of claim 1 wherein each of said plurality of screws is a self-threading screw.

5. The LED light fixture apparatus of claim 2 wherein each of said plurality of screws is a self-threading screw.

6. The LED light fixture apparatus of claim 2 wherein said housing and said cover component are further configured such that the cover component will pop out during attachment to said housing component if the plurality of screws are not properly aligned.

7. A method of constructing an LED light fixture comprising:
constructing a light fixture cover component and a light fixture housing out of heat conductive material;
shaping the cover component to inter-fit with the light fixture housing;
mounting a circuit board carrying one or more LED's on the cover component; and
forming a plurality of screw insertion holes in said cover component disposed at an angle to a surface of said housing selected to allow a screw inserted into a said hole to bite into said surface and to pop out if not properly aligned with said surface.

8. The method of claim 7 further comprising installing a screw into each of said screw insertion holes and thereafter screwing each of said screws into said surface such that each screw bites into said surface and pulls the housing and cover components together.

9. The method of claim 8 further comprising tightening each screw to an extent sufficient to facilitate optimum heat transfer between the housing and cover components for thermal management purposes
